(19) United States
(12) Patent Application Publication
(10) Pub. No.: US 2026/0287075 A1
(43) Pub. Date: Sep. 24, 2026

(54) Inflatable water sports device, valve device and valve system

(71) Applicant: Boards & More GmbH, Molln (AT)

(72) Inventors: Ulrich BITTEROLF, Oberhaching (DE); Aron MATHES, Oberhaching (DE)

(73) Assignee: Boards & More GmbH, Molln (AT)

(21) Appl. No.: 19/367,645

(22) Filed: Oct. 23, 2025

(30) Foreign Application Priority Data
Nov. 8, 2024 (DE) 102024132694.8

(51) Int. Cl. F16K 15/20

(52) U.S. Cl. CPC F16K 15/20

(57) ABSTRACT

An inflatable water sports device includes at least one inflatable structure and a valve device for supplying air to an interior space. The valve device comprises a valve housing with a passage opening and a valve body configured to airtightly close the passage. The valve body is movably mounted and rotatable about an axis relative to the housing. The mounting enables the valve body to rotate from a first angular position, in which it can close the passage, to a second angular position, in which it opens the passage. The rotation occurs over an actuation angle α, where 0°<α<360°. The mounting allows continuous rotation, such that the valve body can repeatedly transition between the two angular positions by rotating through angles defined by βₙ=α+n·360°, where n is an integer, enabling repeated actuation without rotational stops.

### TECHNICAL FIELD

The present invention relates to an inflatable water sports device, a valve device for use with an inflatable water sports device and a valve system.

### BACKGROUND OF THE INVENTION

From the field of water sports and in particular from the field of surf sports, inflatable water sports devices or surf sports devices are known which can only be used as intended after an inflatable structure has been inflated. This has the advantage, among other things, that the devices in question can be transported in a space-saving manner in the uninflated state and only reach their final position intended for use at the destination by the inflation.

Non-limiting examples which may be mentioned are an inflatable wing rig or an inflatable kite, which are surf sports devices, by means of which the user can be dragged on a board over water but also over land (ice, snow, sand, etc.).

In the case of a so-called kite, the user controls the sports device via a so-called bar, to which lines are fastened which connect the bar to an umbrella flying during use. In contrast to this, the user of a wing rig holds the sports device without such lines directly with his hands, either on handles or on a guide rod, a so-called boom.

Typically, an inflatable kite or an inflatable wing rig have an inflatable front tube which serves as a leading edge for the wind. In addition, inflatable transverse tubes which extend substantially transversely with respect to the front tube can also be provided which, in the inflated state, together with the front tube, span a sail cloth.

Other examples of inflatable water sports devices are in each case inflatable canoes, kayaks, boats, raft boats, SUP boards (stand-up paddle boards), surf boards or wing boards.

For filling or emptying the inflatable structures, the latter usually have a valve device which passes through an outer skin of the structure in order to supply or discharge air via the latter to an interior space of the structure. In this case, the supply takes place on account of the comparatively large air volume via a pump device, the connection adapter of which is coupled to the valve device.

With regard to a weight-saving embodiment, such valve devices are usually produced from plastic. In the course of each filling and emptying, in this case the valve device is forcibly actuated, as a result of which the latter is mechanically loaded. This loading increasingly wears the valve device and, with careless handling of the valve device, can even easily lead to damage to the latter, in particular against the background that the water sports devices and therefore also the valve device are regularly exposed to extreme conditions for the material, for example in the form of the pressure loading in the inflated state, UV radiation, heat, cold, salt water, sand, etc.

### SUMMARY

It is therefore an object of the present invention to provide an inflatable water sports device which is more robust with regard to filling and emptying.

In order to achieve this object, an inflatable water sports device according to claim 1, a valve device for use with a water sports device according to claim 17 and a valve system according to claim 22 are provided.

The respective dependent claims relate here to preferred embodiments which can be provided in each case by themselves or in combination.

According to a first aspect of the invention, an inflatable water sports device is provided, which comprises at least one inflatable structure with a valve device, via which air can be supplied to an interior space of the structure. The valve device comprises a valve housing with a passage opening and a valve body for closing the passage opening airtightly, wherein the valve body is movably attached to the valve housing via a mounting. The valve body is rotatable about an axis of rotation relative to the valve housing via the mounting, wherein the mounting is designed such that the valve body, starting from a first angular position, in which the valve body can adopt at least one closed position closing the passage opening, can be brought into a second angular position, in which the valve body can adopt at least one open position releasing the passage opening and in which the valve body cannot adopt a closed position, by rotating about the axis of rotation with an actuation angle α, with 0°<α<360°. The mounting is designed such that it allows a continuous rotation of the valve body, so that the valve body, starting from the first angular position, can be brought into the second angular position by rotating about the axis of rotation with an angle of rotation βₙ=α+n·360° for every n∈ [symbol] .

Correspondingly, it preferably applies that the valve body, starting from the second angular position, can be brought into the first angular position by rotating about the axis of rotation with an angle of rotation

$${β}_{n}^{*} = ( - {β}_{n} ) = - α - n \cdot 360 °$$

for every n∈ [symbol] ( [symbol] as a set of integers).

When rotating about the axis of rotation, a sign of the angle of rotation indicates a direction of rotation. Thus, a positive angle of rotation means that the valve body is rotated relative to the valve housing, for example, in the mathematically positive sense, whereas a negative angle of rotation means that the valve body is rotated relative to the valve housing, for example, in the mathematically negative sense.

A rotational orientation of the valve body relative to the valve housing is indicated via an angular position which, in relation to the axis of rotation, describes a rotation angle between a body-fixed coordinate system of the valve body and a body-fixed coordinate system of the valve housing. Thus, the angular position necessarily only assumes values greater than or equal to 0° and less than 360°. The first and the second angular position are in this case specific angular positions in which the rotation angle, related to the reference axis, of the two coordinate systems differs by the actuation angle α.

With the water sports device provided by the invention, a water sports device is provided in which the valve body can be continuously rotated in both directions of rotation continuously and without a stop relative to the valve housing and in this case passes the first angular position and the second angular position repeatedly and alternately.

To this extent, a kind of overrotation protection is provided by this embodiment, with the result that the valve device is not destroyed by overrotation, for example as a result of careless actuation by the user. Thus, in the event of overrotation beyond the first/second angular position, the second/first angular position can be reached again in the event of further rotation in the same direction of rotation.

A safety mechanism is therefore provided which reliably prevents accidental damage to the valve device, in particular by inexperienced users.

An open position corresponds to a relative positioning of valve body and valve housing in which the passage opening is open. A closed position corresponds to a relative positioning of valve body and valve housing in which the passage opening is closed.

The circumstance that the valve body cannot assume a closed position in the second angular position means that the passage opening cannot be closed by the valve body when the latter is in the second angular position. In other words, the valve device cannot be closed when the valve body is in the second angular position.

The second angular position therefore preferably corresponds to an open configuration in which the valve device is permanently open and cannot be closed as long as the valve body is still in the second angular position. Such a configuration reduces, for example, the resistance during filling of the structure and also facilitates emptying of the latter.

Preferably, the valve body can adopt a plurality of open positions in the second angular position.

Preferably, the valve body can also adopt one or more open positions in addition to the closed position in the first angular position, such that the passage opening can be opened and also closed by the valve body when the latter is in the first angular position. In other words, the valve device can be opened and closed when the valve body is in the first angular position.

Thus, when the valve body is brought into the first angular position, the valve device can be designed in particular as a non-return valve, which allows a flow of the air only in one direction, here in the direction of the interior space of the structure.

In the closed position(s), in particular a closure section of the valve body is in contact with the valve housing. Preferably, the closure section comprises an additional sealing element which is in contact with the valve housing in the closed position(s).

The valve housing is preferably immovably fastened to an outer skin of the inflatable structure, such that the valve housing penetrates the latter. Preferably, the valve housing comprises a first housing part and a second housing part, which are in particular releasably connected to one another, wherein, in the assembled state, the first and the second housing part clamp a section of the outer skin between them. Preferably, the valve housing comprises an additional sealing element in such an interface between the first and the second housing part.

Preferably, the second housing part is arranged for the most part in the interior space of the inflatable structure and the first housing part is arranged for the most part outside the interior space.

Preferably, the first and the second housing part can be releasably connected to one another via a threaded pairing.

Preferably, the valve housing and/or the valve body are produced from a plastic or a composite material.

Preferably, the first housing part comprises an inner body, which has a passage channel for the air, which passage channel forms the passage opening. In particular, the inner body has a valve seat adapted to the valve body or to the closure section thereof.

Preferably, the first housing part furthermore comprises a clamping ring which is adapted to the second housing part and can be fastened to the latter, via which clamping ring the inner body and the second housing part can be tensioned to one another. In particular, in the case of a threaded pairing, the clamping ring has the threaded section of the first housing part.

Preferably, the first and the second housing part are of substantially annular configuration.

The mounting can be formed by sections of the valve housing and/or of the valve body itself. In other words, the valve-housing-side and/or the valve-body-side components of the mounting are embodied integrally with the valve housing or with the valve body.

However, the mounting of the valve device can also comprise additional bearing elements which are fastened to the valve housing and/or to the valve body and which correspondingly correspond to the valve-housing-side and/or the valve-body-side component of the mounting.

In a preferred embodiment, the valve body is locked in the first and/or the second angular position via the mounting, such that a resistance against a rotation of the valve body out of the first and/or second angular position is greater than a resistance against a rotation out of an intermediate angular position, which lies between the first and the second angular position.

As a result, the risk of an undesired adjustment is minimized. In addition, the user can so easily recognize that the valve body is located in the first or second angular position.

In a preferred embodiment, the valve body is displaceable relative to the valve housing along a stroke axis via the mounting.

As a result, a closing mechanism which is comparatively simple to implement is provided, wherein displacements of the valve body along the stroke axis are also referred to as stroke movements.

In this case, “along the stroke axis” means that the valve body can be displaced in principle both in the positive and in the negative direction of the stroke axis, provided that said valve body is not located in a locked position or in a stop position.

Preferably, the stroke axis and thus a direction of stroke movements of the valve body runs parallel to a main flow direction of the valve device. Preferably, contact surfaces of the closure section of the valve body and of the valve housing, which are in contact with one another in the closed position, are at an angle, in particular at a right angle, to the stroke axis and in particular to the main flow direction.

Particularly preferably, the valve body lies in its closed position between the contact surface of the valve housing and the interior space of the inflatable structure.

In this way, a pneumatic pressure which is present in the interior space presses against the valve body in the direction of the contact with the valve housing and in this case preferably increases the contact force which acts from the valve body via the contact surfaces on the valve housing, which in turn increases the sealing action. The contact force can also be referred to, for example, as a contact pressure force which corresponds to the resulting force of the contact pressure which acts in the contact surface.

Preferably, the mounting is configured such that a rotation of the valve body brings about a stroke movement of the valve body. As a result, the valve body is brought by rotation alone into different stroke positions in which it can preferably also be locked in a form-fitting and/or force-fitting manner in order to implement a constant stroke position.

In a preferred embodiment, a valve stroke in the first angular position is unequal to a valve stroke in the second angular position, wherein the valve stroke describes the possible movement range for stroke movements of the valve body relative to the valve housing along the stroke axis.

As a result, a different valve stroke can be set at least for the first and second angular position of the valve body, by means of which different configurations of the valve device can in turn be set easily for these angular positions. Thus, for example, an open configuration can be selected for the second angular position in which the valve stroke is defined such that the valve body can be moved in the second angular position by stroke movements only between a plurality of open positions and the passage opening cannot be closed. Furthermore, for example, a configuration can be selected as a non-return valve for the first angular position in which the valve stroke is defined such that the valve body can be moved in the first angular position by stroke movements between the closed position and one or more open positions.

In a preferred embodiment, the mounting defines, at least for the first and for the second angular position of the valve body, preferably for each angular position of the valve body, in relation to a body-fixed stroke reference point of the valve housing, in each case a lower stroke end position and an upper stroke end position which determine the valve stroke and between which the valve body is displaceable relative to the valve housing along the stroke axis in the respective angular position.

The valve stroke for a specific angular position is thus defined by the lower and the upper stroke end position in this angular position.

For an angular position, the lower stroke end position can be equal to or unequal to the upper stroke end position. In the former case, in which the upper and lower stroke end positions coincide, the valve body cannot be displaced along the stroke axis in this angular position, at least not without changing the angular position of the valve body in the process.

A stroke position of the valve body describes a position of the valve body relative to the stroke reference point in the direction of the stroke axis and can lie between the associated lower and upper stroke end position for a specific angular position.

Preferably, at least one lower stroke end position in the first angular position is unequal to a lower stroke end position in the second angular position, and the valve body adopts the closed position when it is located in the lower stroke end position in the first angular position, and adopts the open position when it is located in the lower stroke end position in the second angular position.

Preferably, for the first and for the second angular position, in each case the upper stroke end position is unequal to the lower stroke end position.

Preferably, the upper stroke end position in the first angular position corresponds to the upper stroke end position in the second angular position. Particularly preferably, the upper stroke end positions are equal for each angular position.

In a preferred embodiment, the valve stroke is greater in the first angular position than in the second angular position.

In a preferred embodiment, the mounting has a guide contour and one or more guide sections which are adapted thereto and which are movable relative to one another by rotation of the valve body, wherein the guide contour defines a lower stroke end position for each angular position of the valve body by interaction with the one or more guide sections.

As a result, the lower stroke end positions can be defined in a simple manner in a kind of slotted guide as a function of the angular position of the valve body.

In a preferred embodiment, the guide contour is designed as part of the valve housing and the one or more guide sections are designed as part of the valve body.

Alternatively, the guide contour can be designed as part of the valve body and the guide section can be designed as part of the valve housing.

Preferably, the guide contour and the one or more guide sections are embodied integrally with the valve body or the valve housing.

In a preferred embodiment, a contour curve of the guide contour in a circumferential direction orthogonal to the axis of rotation is a curve which is continuous over an angular range of 0° to 360°.

As a result, a continuous profile of the lower stroke end position over the angular positions can be provided, which reduces the risk of wedging or sticking during rotation of the valve body.

In a preferred embodiment, the valve device comprises a restoring element, in particular in the form of an elastic spring, which exerts a restoring force on the valve body, by means of which restoring force the valve body is tensioned in the first angular position in the lower stroke end position of the first angular position.

As a result, it is ensured that the valve body remains in its closed position without a sufficiently high air inlet pressure and closes the passage opening airtightly. If a sufficiently high air inlet pressure is applied, the pressure force which acts on the valve body overcomes the restoring force and the valve body is moved out of its closed position.

Preferably, the guide contour is designed such that the restoring element brings the valve body, which is located between the first and second angular positions, back into the first angular position if no actuating force acts on the valve body, for example by a user. As a result, a safety function can be implemented which always brings the valve body into the angular position in which it can adopt its closed position.

In a preferred embodiment, a direction of the stroke axis corresponds to a direction of the axis of rotation.

As a result, a kinematic for the valve device which is simple to implement is made possible, in particular with regard to the configuration of the mounting.

In a preferred embodiment, the mounting is designed such that the valve body, starting from a third angular position, which corresponds neither to the first nor to the second angular position and in which the valve body can adopt a further closed position closing the passage opening, can be brought into a fourth angular position, which corresponds neither to the first nor to the second angular position and in which the valve body can adopt a further open position releasing the passage opening and in which the valve body cannot adopt a closed position, by rotating about the axis of rotation with an actuation angle γ, with 0°<γ<360°, wherein the valve body, starting from the third angular position, can be brought into the fourth angular position by rotating about the axis of rotation with an angle of rotation δₙ=γ+n·360° for every n∈ [symbol] by means of the mounting allowing the continuous rotation.

Correspondingly, it preferably applies that the valve body, starting from the fourth angular position, can be brought into the first angular position by rotating about the axis of rotation with an angle of rotation

$${δ}_{n}^{*} = ( - {δ}_{n} ) = - γ - n \cdot 360 °$$

for every n∈ [symbol] .

As a result, the number of different angular positions is increased, so that a rotation required for changing the angular position is made smaller.

The valve device can be designed analogously for the third and fourth angular position according to each of the embodiments described above with regard to the first and the second angular position, wherein the embodiments relating to the first angular position can also be selected analogously for the third angular position and the embodiments relating to the second angular position can also be selected analogously for the fourth angular position.

In particular, the valve body can also adopt one or more further open positions in addition to the further closed position in the third angular position, such that the passage opening can be opened and also closed by the valve body when the latter is in the third angular position. In other words, the valve device can be opened and closed when the valve body is in the third angular position.

In particular, the valve body can adopt a plurality of further open positions in the fourth angular position and cannot adopt a closed position in this fourth angular position, such that the passage opening cannot be closed by the valve body when the latter is in the fourth angular position. In other words, the valve device cannot be closed when the valve body is in the fourth angular position.

In a preferred embodiment, the mounting is designed such that the valve body, starting from the second angular position, can be brought into the third angular position by rotating about the axis of rotation with an actuation angle θ, with 0°<θ<360°, and α+γ+θ<360° applies, wherein preferably 80°≤α≤100° and/or 80°≤δ≤100° and/or 80°≤θ≤100° applies.

In a preferred embodiment, the mounting is designed such that the valve body, starting from the third angular position, can be brought into the first angular position by rotating about the axis of rotation with an actuation angle φ, with 0°<φ<360°, and preferably α+γ+0+¢=360° applies.

As a result, only short rotational movements are required for changing between the angular positions, with a uniform embodiment preferably in each case 90° rotational movements.

In a preferred embodiment, the valve body comprises a closure section adapted to the passage opening, an operating section, via which the valve body can be rotated, and a connecting section arranged therebetween, wherein the mounting engages in particular in the region of the connecting section.

As a result, a simple construction with a plurality of sections is provided, wherein each section has a separate main function.

In a preferred embodiment, the valve housing has a fastening section which is adapted to a connection adapter which is designed for use with a pump device such that the connection adapter can be brought into interaction with the fastening section by inserting and rotating relative to the valve housing in order to releasably fasten the connection adapter to the valve housing, and the fastened connection adapter can be separated from the fastening section by rotating and extracting from the valve housing in order to release the fastened connection adapter from the valve housing.

As a result, a connection between a pump device and the valve device can be produced in a simple manner.

In a preferred embodiment, the operating section of the valve body is adapted to an actuating section of the connection adapter such that, by inserting and rotating the connection adapter in order to engage the releasable fastening of the connection adapter to the valve housing, the actuating section rotates the valve body from an angular position, which is not the first angular position, into the first angular position via interaction with the operating section.

Alternatively or additionally, the operating section of the valve body can be adapted to the actuating section of the connection adapter such that, by rotating the fastened connection adapter in order to release the fastening of the connection adapter to the valve housing, the actuating section rotates the valve body from an angular position, which is not the first angular position, into the first angular position via interaction with the operating section.

In this way, an angular position of the valve body can be changed without direct operation of the operating section, in particular in the course of an action which is required in any case during inflation, namely the connection and/or separation of the valve device to/from the connection adapter.

As a result, it is ensured that, when the connection adapter is released, the valve body is located in the first angular position in which it can adopt its closed position in order to prevent an undesired escape of the air from the structure.

Furthermore, the valve device is particularly advantageously suitable for use with such a connection adapter since, in this case, accidental overrotation of the valve body when the connection adapter is screwed in does not lead to destruction of the valve device. A risk of undesired overrotation is substantially higher in comparison with use without a connection adapter since, precisely when the connection adapter is inserted, the user cannot visually detect the position in which the valve body is currently located.

In a preferred embodiment, the operating section of the valve body is adapted to the actuating section of the connection adapter such that, by inserting and rotating the connection adapter in order to engage the releasable fastening of the connection adapter to the valve housing, the actuating section displaces the valve body out of its lower stroke end position via interaction with the operating section.

As a result, the valve body can in any case be moved out of its closed position in order to open up the passage opening, which reduces, for example, a resistance during inflation by the pump device which would otherwise also have to additionally overcome the prestressing of the restoring element during inflation.

In a preferred embodiment, the water sports device is a surf sports device, in particular a wing rig or a kite, and the inflatable structure is preferably an inflatable front tube of the kite or of the wing rig or an inflatable middle tube or transverse tube of the kite or of the wing rig.

Furthermore, however, the water sports device can also be an inflatable board, for example an inflatable surf board or a so-called stand-up paddle board. Furthermore, the water sports device can also be in each case an inflatable canoe, kayak, boat, raft boat or wing board.

The more robust valve device is suitable in particular for use with such surf sports devices which are generally exposed to extreme ambient conditions, for example in the form of the pressure loading in the inflated state, UV radiation, heat, cold or salt water, which fatigue the material of the valve device comparatively quickly and thus make it more susceptible to damage, in particular in the case of careless operation. Thus, the valve device with the above-described overrotation protection prevents undesired overrotation, for example.

The term “tube” is a technical term in the technical field and denotes substantially hose-like or tube-like structures which are stiffened in particular by inflation.

The “front tube” is likewise a technical term in the technical field and denotes a tube which is arranged at the front of the surf sports device and serves as a leading edge for the wind.

According to a second aspect of the invention, a valve device for use on a water sports device, in particular a valve device of a water sports device according to the first aspect or one of the preferred embodiments thereof, is provided. The valve device comprises a valve housing with a passage opening and a valve body for closing the passage opening airtightly, wherein the valve body is movably attached to the valve housing via a mounting, wherein the valve body is rotatable about an axis of rotation relative to the valve housing via the mounting such that the valve body, starting from a first angular position, in which the valve body can adopt a closed position closing the passage opening, can be brought into a second angular position, in which the valve body can adopt an open position releasing the passage opening and in which the valve body cannot adopt a closed position, by rotating about the axis of rotation with an actuation angle β, with 0°<β≤180°, and the mounting is designed such that it allows a continuous rotation of the valve body, so that the valve body, starting from the first angular position, can be brought into the second angular position by rotating about the axis of rotation with an angle of rotation αₙ=β+n·360° for every n∈ [symbol] .

Thus, a valve device is provided which can be used, for example, for retrofitting a water sports device. The valve device provided corresponds substantially to the valve device of the water sports device according to the first aspect and is likewise distinguished by all the advantages achieved thereby.

The valve device can be configured according to each of the embodiments described in the context of the water sports device. A repeated reproduction of the individual embodiments is dispensed with at this point.

According to a third aspect of the invention, a valve system for use on a water sports device, in particular a water sports device according to the first aspect or one of the preferred embodiments thereof, is provided. The valve system comprises a connection adapter which can be connected to an outlet of a pump device, and a valve device at least according to the second aspect of the invention, wherein the connection adapter is adapted to a fastening section of the valve housing of the valve device such that the connection adapter can be brought into interaction with the fastening section by inserting and rotating relative to the valve housing in order to releasably fasten the connection adapter to the valve housing, and the fastened connection adapter can be separated from the fastening section by rotating and extracting from the valve housing in order to release the fastened connection adapter from the valve housing, and the connection adapter has an actuating section which is adapted to an operating section of the valve body of the valve device such that, by inserting and rotating the connection adapter in order to engage the releasable fastening of the connection adapter to the valve housing, the actuating section rotates the valve body from an angular position, which is not the first angular position, into the first angular position via interaction with the operating section, and/or the operating section of the valve body is adapted to the actuating section of the connection adapter such that, by rotating the fastened connection adapter in order to release the fastening of the connection adapter to the valve housing, the actuating section rotates the valve body from an angular position, which is not the first angular position, into the first angular position via interaction with the operating section.

Further aspects and the advantages thereof and also more specific exemplary embodiments of the abovementioned aspects and embodiments are described below with the aid of the drawings shown in the attached figures.

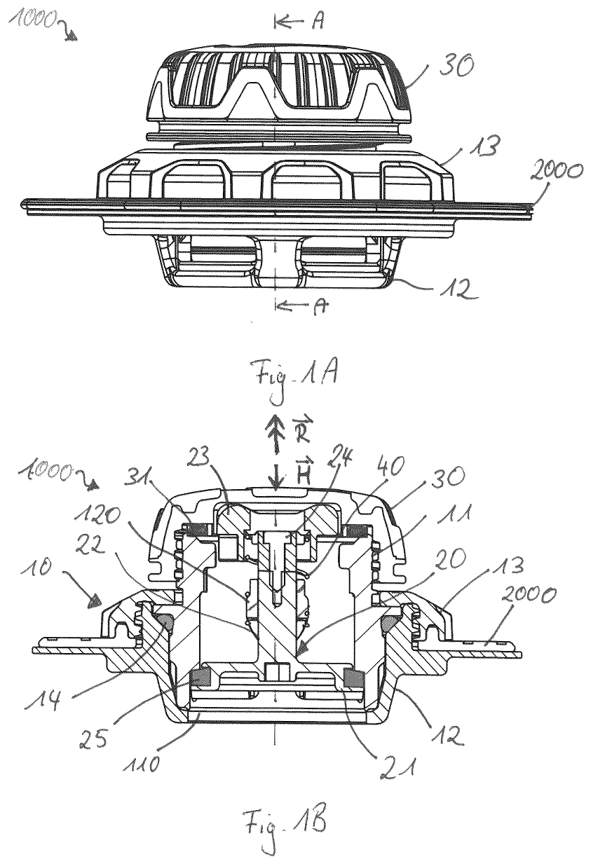

FIGS. 1A to 1D show different views of an exemplary embodiment of the valve device according to the invention or of components of the valve device.

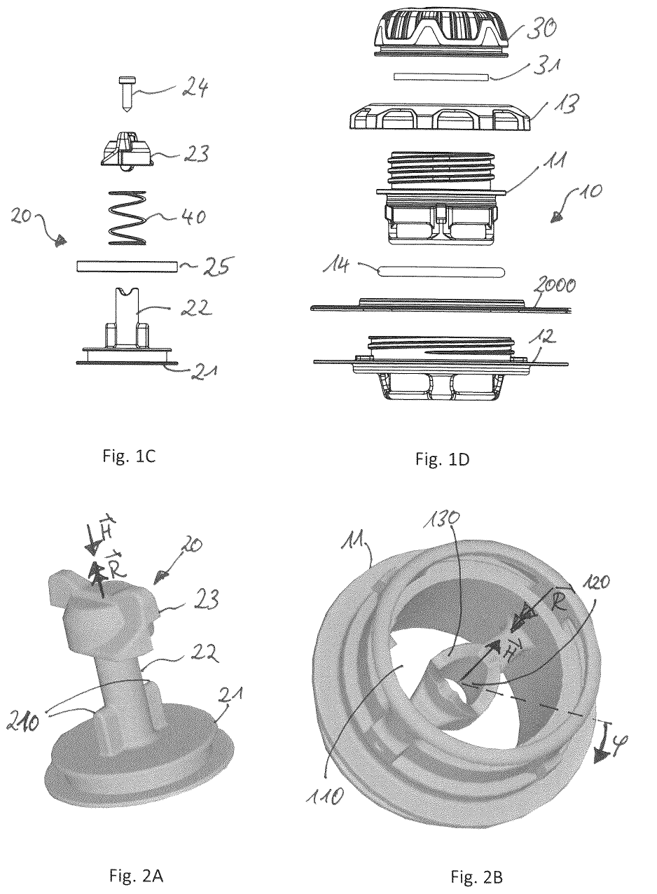

FIGS. 2A and 2B show perspective views of components of an exemplary embodiment of the valve device according to the invention. In this regard, FIG. 2C shows an exemplary contour curve of a guide contour of the component from FIG. 2B.

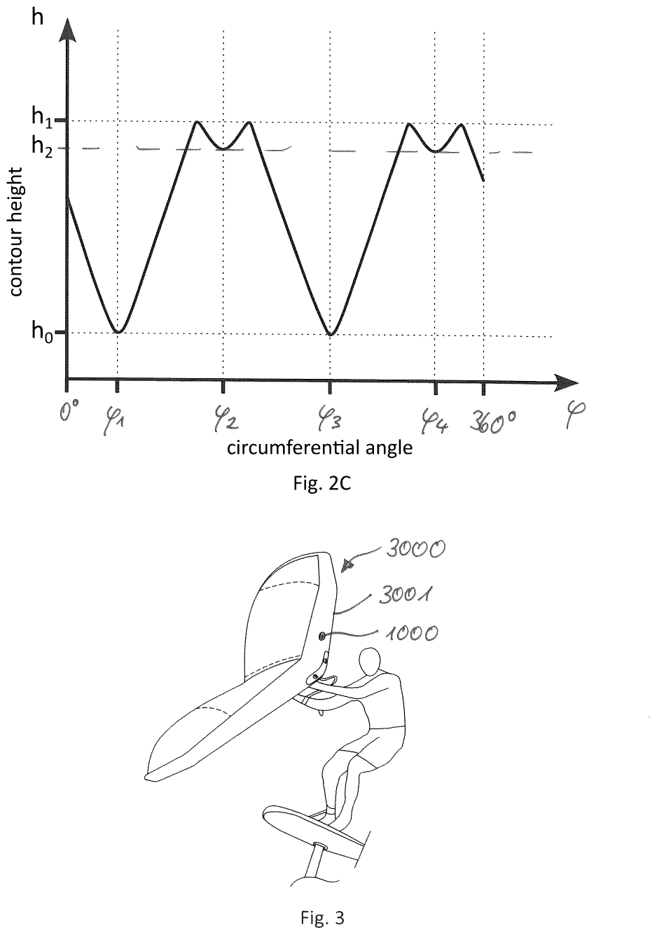

FIG. 3 shows a perspective view of an exemplary embodiment of the water sports device according to the invention, here in the form of a wing rig.

It is emphasized that the present invention is in no way limited to the exemplary embodiments described below and the exemplary features thereof. The invention furthermore comprises modifications of the exemplary embodiments mentioned, in particular those which emerge from modifications and/or combinations of individual or a plurality of features of the exemplary embodiments described within the scope of protection of the independent claims.

### DETAILED DESCRIPTION OF THE FIGURES

FIGS. 1A to 1D show different views of an exemplary embodiment of the valve device 1000 according to the invention or of components of the valve device 1000.

In this regard, FIG. 1A shows a side view, FIG. 1B shows a cross section through the sectional plane A-A drawn in FIG. 1A, FIG. 1C shows an exploded illustration of a valve body assembly, and FIG. 1D shows an exploded illustration of a valve housing assembly.

FIGS. 1A to 1D are described jointly below.

The valve device 1000 comprises a valve housing 10 with a passage opening 110 and a valve body 20 for closing the passage opening 110 airtightly, wherein the valve body is movably attached to the valve housing 10 via a mounting.

The valve body 20 is rotatable about an axis of rotation R relative to the valve housing 10 via the mounting, wherein the mounting is designed such that the valve body 20, starting from a first angular position, in which the valve body 20 can adopt at least one closed position closing the passage opening 110, can be brought into a second angular position, in which the valve body 20 can adopt at least one open position releasing the passage opening 110 and in which the valve body cannot adopt a closed position, by rotating about the axis of rotation R with a predefined actuation angle α, with 0°<α<360°.

The mounting is designed such that it allows a continuous rotation of the valve body 20, so that the valve body 20, starting from the first angular position, can be brought into the second angular position by rotating about the axis of rotation R with an angle of rotation βₙ=α+n·360° for every n∈ [symbol] .

In this case, FIGS. 1A and 1B show a configuration of the valve device with the valve body 20 which is in the first angular position and which is in the closed position.

The valve body 20 comprises a closure section 21 adapted to the passage opening 110, an operating section 23, via which the valve body 20 can be rotated, and a connecting section 22 arranged therebetween, which can be embodied either integrally, partially integrally or separately. In the present exemplary embodiment, the connecting section 22 and the closure section 21 are embodied integrally and the separate operating section 23 is fastened to the connecting section 22 via a screw 24.

Furthermore, the valve body preferably comprises a valve body seal 25 in the region of the closure section 21.

The valve housing 10 comprises, for example, a first housing part and a second housing part, which are releasably connected to one another, wherein, in the assembled state, the first and the second housing part clamp a section 2000 of the outer skin (illustrated here in the form of a reinforcing section) between them. Preferably, the valve housing 10 comprises an additional seal 14 in such an interface between the first and the second housing part.

In a state in which it is mounted on the inflatable structure, the second housing part is arranged for the most part in the interior space of the inflatable structure and the first housing part is arranged for the most part outside the interior space.

The second housing part preferably comprises a mounting body 12 and the first housing part preferably comprises an inner body 11 and a clamping ring 13, wherein the clamping ring can be fastened to the mounting body 12, in order to tension the first housing part to the second housing part and in the process in particular to clamp the section 2000 of the outer skin between them. In the present case, the fastening of the clamping ring takes place via an exemplary threaded pairing.

Furthermore, the valve device 1000 preferably also has a valve cover 30 with a cover seal 31 for protecting the interior life, wherein the cover can be fastened to the valve housing 10.

The inner body 11 preferably has the passage opening 110 and a mounting section 120, which is part of the mounting of the valve body 20 and, in the assembled state, engages on the connecting section 22 of the valve body 20.

The valve body 20 is displaceable relative to the valve housing 10 along a stroke axis H via the mounting, wherein a possible valve stroke along the stroke axis H depends on an angular position of the valve body 20.

Thus, the mounting defines, at least for the first and for the second angular position of the valve body 20, preferably for each angular position of the valve body 20, in relation to a body-fixed stroke reference point of the valve housing 10, in each case a lower stroke end position and an upper stroke end position between which the valve body 20 is displaceable relative to the valve housing 10 along the stroke axis H in the respective angular position.

The valve body 20 adopts the closed position when it is located in the lower stroke end position in the first angular position, as is illustrated, for example, in FIG. 1B. Starting from the lower stroke end position, the mounting now permits a stroke movement in the positive direction of the stroke axis H via which the valve body 20 is displaced out of the closed position in order thus to open up the passage opening 110. In this way, the valve device 1000 according to the exemplary embodiment acts as a kind of non-return valve in the first angular position.

For this purpose, the valve device 1000 preferably has a restoring element 40 as part of the mounting, in particular in the form of an elastic spring, which exerts a restoring force on the valve body 20, by means of which restoring force the valve body 20 is tensioned in the first angular position in the lower stroke end position of the first angular position. In the exemplary embodiment shown, the restoring force which acts on the valve body is directed in the negative direction of the stroke axis H.

Preferably, the mounting is designed such that the restoring element 40 brings the valve body 20, which is located between the first and second angular positions, back into the first angular position if no actuating force acts on the valve body 20, for example by a user.

The valve body 20 adopts the open position when it is located in the lower stroke end position in the second angular position which, with respect to the positive direction of the stroke axis H, preferably lies above the lower stroke end position of the first angular position.

Starting from the lower stroke end position of the second angular position, the mounting now permits a stroke movement in the positive direction of the stroke axis H via which the valve body 20 cannot be displaced into a closed position. In this way, the valve device 1000 according to the exemplary embodiment acts as a kind of permanently open valve in the second angular position.

By rotating the valve body 20, the latter can be brought from the first into the second angular position (and vice versa) in order thus to switch over between the two above configurations (permanently open, non-return valve).

The mounting which allows the continuous rotation in this case provides a kind of overrotation protection, with the result that the valve device 1000 is not destroyed by overrotation of the valve body, for example as a result of careless actuation by the user. Thus, in the event of overrotation of the valve body 20 beyond the first/second angular position, the second/first angular position can be reached again in the event of further rotation in the same direction of rotation without damaging the valve device 1000 in the process.

FIGS. 2A and 2B show perspective views of components of an exemplary embodiment of the valve device according to the invention. In this regard, FIG. 2C shows an exemplary contour curve of a guide contour 130 of the component from FIG. 2B.

In this regard, FIG. 2A shows a valve body 20, and FIG. 2B shows an inner body 11 of a valve housing of the exemplary embodiment of the valve device according to the invention, which are illustrated separately from one another. In an assembled state of the valve device, the valve body 20 would be inserted into a mounting section 120 of the inner body 11 (see also FIG. 1B in this regard).

The valve device comprises at least one valve housing with a passage opening 110 and a valve body 20 for closing the passage opening 110 airtightly, wherein the valve body is movably attached to the valve housing or to the inner body 11 via a mounting. The valve body 20 is rotatable about an axis of rotation R relative to the valve housing or relative to the inner body 11 via the mounting, wherein the mounting is designed such that the valve body 20, starting from a first angular position, in which the valve body 20 can adopt a closed position closing the passage opening, can be brought into a second angular position (2, in which the valve body 20 can adopt an open position releasing the passage opening 110 and in which the valve body cannot adopt a closed position, by rotating about the axis of rotation R with an actuation angle α, with 0°<α<360°. The mounting is designed such that it allows a continuous rotation of the valve body 20, so that the valve body 20, starting from the first angular position, can be brought into the second angular position by rotating about the axis of rotation R with an angle of rotation βₙ=α+n·360° for every n∈ [symbol] .

The valve body 20 is displaceable relative to the valve housing 10 along a stroke axis H via the mounting, wherein a possible valve stroke along the stroke axis H depends on an angular position of the valve body 20.

Thus, the mounting defines, at least for the first and for the second angular position of the valve body 20, preferably for each angular position of the valve body 20, in relation to a body-fixed stroke reference point of the valve housing 10, in each case a lower stroke end position and an upper stroke end position between which the valve body 20 is displaceable relative to the valve housing 10 along the stroke axis H in the respective angular position.

The valve body 20 adopts the closed position when it is located in the lower stroke end position in the first angular position. The valve body 20 adopts the open position when it is located in the lower stroke end position in the second angular position which, with respect to the positive direction of the stroke axis H, preferably lies above the lower stroke end position of the first angular position.

For the definition of the lower stroke end positions in the respective angular positions, the mounting has a guide contour 130 and one or more guide sections 210 adapted thereto. In the present case, the guide contour 130 is designed as part of the inner body 11 and the valve body here has, by way of example, two guide sections 210 which are adapted thereto and which are movable relative to the guide contour 130 by rotation of the valve body 20.

In this case, the guide contour 130 defines, in interaction with the one or more guide sections 210, a lower stroke end position for each angular position of the valve body 20.

As can be gathered from the combined view of FIGS. 2A and 2B, the guide sections 210 can be moved along the guide contour 130 by rotation of the valve body in the assembled state, wherein a contact point between said guide sections varies with respect to a position in the direction of the stroke axis H with rotation of the valve body 20 and thus defines lower stroke end positions.

For this purpose, for example, a contour height of the guide contour 130 varies above a body-fixed stroke reference point of the inner body 11 in relation to the direction of the stroke axis Hover a circumferential angle φ of the inner body 11.

In this regard, FIG. 2C shows an exemplary contour curve of a guide contour 130 of the component from FIG. 2B, in which a contour heighth of the guide contour is plotted above a body-fixed stroke reference point of the inner body 11 in relation to the direction of the stroke axis Hover a circumferential angle φ of the inner body 11.

By way of example, the contour height moves between the height values h₀ and h₁ and defines lower stroke end positions of the valve body 20 for the stroke movements thereof.

If, for example, a first of the guide sections 210 is located in a position φ=φ₁ in relation to the inner body 11, a minimum achievable distance of a contact point of the guide section 210 from the stroke reference point is the value h₀ for this angular position.

In this case, this position would correspond in particular to the first angular position of the valve body 20.

If, for example, the first guide section 210 is located in a position q=42 in relation to the inner body 11, a minimum achievable distance of a contact point of the guide section 210 from the stroke reference point is the value h₂ for this angular position.

In this case, this position would correspond in particular to the second angular position of the valve body 20 in which, on account of the described minimum distance h₂, the valve body or the closure section 21 thereof cannot adopt a closed position for closing the passage opening.

In a region around the angular positions q=42 and q=44, the contour curve has sections whose contour height is greater than the value h₂, as a result of which a local minimum of the contour height is provided there, which local minimum fulfils a locking function in the assembled state. In this way, a rotation of the valve body is made more difficult by the first guide section 210 first having to overcome the local maxima at the height h₁ around the angular positions φ=φ₂ and Ω=φ₄ in order to rotate the valve body 20.

The contour curve is preferably a curve which is continuous over the angular range and, in particular, this is a continuously differentiable curve. In the present case, the contour curve is in particular a n periodic curve on account of the two guide sections 210 which are offset by 180°.

Preferably, the mounting is designed such that the valve body 20, starting from a third angular position, which corresponds neither to the first nor to the second angular position and in which the valve body 20 can adopt a further closed position closing the passage opening 110, can be brought into a fourth angular position, which corresponds neither to the first nor to the second angular position and in which the valve body 20 can adopt a further open position releasing the passage opening 110 and in which the valve body cannot adopt a closed position, by rotating about the axis of rotation with an actuation angle γ, with 0°<<360°, wherein the valve body 20, starting from the third angular position, can be brought into the fourth angular position by rotating about the axis of rotation with an angle of rotation δₙ=γ+n·360° for every n EZ by means of the mounting allowing the continuous rotation.

Said third angular position would be adopted in this case if the first guide section 210 were located in a position φ=43 in relation to the inner body 11, and said fourth angular position would be adopted in this case if the first guide section 210 were located in a position φ=44 in relation to the inner body 11.

FIG. 3 shows a perspective view of an exemplary embodiment of the water sports device according to the invention, here in the form of a wing rig 3000.

The wing rig 3000 comprises at least one inflatable structure in the form of a front tube 3001 with a valve device 1000, via which air can be supplied to an interior space of the front tube 3001.

The valve device 1000 can be embodied, for example, in the form of the exemplary embodiment from FIGS. 1A to 1D, but can also deviate therefrom.

The valve device 1000 comprises at least one valve housing with a passage opening and a valve body for closing the passage opening airtightly, wherein the valve body is movably attached to the valve housing via a mounting. The valve body is rotatable about an axis of rotation relative to the valve housing via the mounting, wherein the mounting is designed such that the valve body, starting from a first angular position, in which the valve body can adopt a closed position closing the passage opening, can be brought into a second angular position, in which the valve body can adopt an open position releasing the passage opening and in which the valve body cannot adopt a closed position, by rotating about the axis of rotation with an actuation angle α, with 0°<α<360°. The mounting is designed such that it allows a continuous rotation of the valve body, so that the valve body, starting from the first angular position, can be brought into the second angular position by rotating about the axis of rotation with an angle of rotation βₙ=α+n·360° for every n∈ [symbol] .

Exemplary embodiments of the present invention and the advantages thereof have been described in detail above with reference to the attached figures.

It is again emphasized that the present invention is in no way limited to the exemplary embodiments described above and the exemplary features thereof. The invention furthermore comprises modifications of the exemplary embodiments mentioned, in particular those which emerge from modifications and/or combinations of individual or a plurality of features of the exemplary embodiments described within the scope of protection of the independent claims.

List of Reference Signs

| | |
|---|---|
| 10 | Valve Housing |
| 11 | Inner Body |
| 12 | Mounting Body |
| 13 | Clamping Ring |
| 14 | Seal |
| 20 | Valve Body |
| 21 | Closure section |
| 22 | Connecting section |
| 23 | Operating section |
| 24 | Screw |
| 25 | Valve body seal |
| 30 | Valve cover |
| 31 | Cover seal |
| 40 | Restoring element |
| 110 | Passage opening |
| 120 | Bearing section |
| 130 | Guide contour |
| 210 | Guide section |
| 1000 | Valve device |
| 2000 | Section of the outer skin of the inflatable structure |
| 3000 | Wing |
| 3001 | Front tube |

1. An inflatable water sports device, which comprises at least one inflatable structure with a valve device, via which air can be supplied to an interior space of the structure and which comprises a valve housing with a passage opening and a valve body for closing the passage opening airtightly, wherein the valve body is movably attached to the valve housing via a mounting,
wherein the valve body is rotatable about an axis of rotation relative to the valve housing via the mounting, wherein the mounting is designed such that the valve body, starting from a first angular position, in which the valve body can adopt a closed position closing the passage opening, can be brought into a second angular position, in which the valve body can adopt an open position releasing the passage opening and in which the valve body cannot adopt a closed position, by rotating about the axis of rotation with an actuation angle α, with 0°<α<360°,
and the mounting is designed such that it allows a continuous rotation of the valve body, so that the valve body, starting from the first angular position, can be brought into the second angular position by rotating about the axis of rotation with an angle of rotation βₙ=α+n·360° for every n∈ [symbol] .

2. The water sports device according to claim 1, wherein
the valve body is locked in the first and/or the second angular position via the mounting, such that a resistance against a rotation of the valve body out of the first and/or second angular position is greater than a resistance against a rotation out of an intermediate angular position, which lies between the first and the second angular position.

3. The water sports device according to one of claim 1 or 2, wherein
the valve body is displaceable relative to the valve housing along a stroke axis via the mounting.

4. The water sports device according to claim 3, wherein
a valve stroke in the first angular position is unequal to a valve stroke in the second angular position, wherein the valve stroke describes the possible movement range for stroke movements of the valve body relative to the valve housing along the stroke axis.

5. The water sports device according to claim 4, wherein
the valve stroke in the first angular position is greater than the valve stroke in the second angular position.

6. The water sports device according to one of claim 4 or 5, wherein
the mounting has, at least for the first and for the second angular position of the valve body, preferably for each angular position of the valve body, in relation to a body-fixed stroke reference point of the valve housing, in each case a lower stroke end position and an upper stroke end position which determine the valve stroke and between which the valve body is displaceable relative to the valve housing along the stroke axis in the respective angular position,
wherein at least one lower stroke end position in the first angular position is unequal to a lower stroke end position in the second angular position, and the valve body adopts the closed position when it is located in the lower stroke end position in the first angular position, and adopts the open position when it is located in the lower stroke end position in the second angular position.

7. The water sports device according to claim 6, wherein
the mounting has a guide contour and one or more guide sections which are adapted thereto and which are movable relative to one another by rotation of the valve body, wherein the guide contour defines a lower stroke end position for each angular position of the valve body by interaction with the one or more guide sections.

8. The water sports device according to claim 7, wherein
the guide contour is designed as part of the valve housing and the one or more guide sections are designed as part of the valve body.

9. The water sports device according to one of claim 7 or 8, wherein
a contour curve of the guide contour in a circumferential direction orthogonal to the axis of rotation is a curve which is continuous over an angular range of 0° to 360°.

10. The water sports device according to one of claims 6 to 9, wherein
the valve device comprises a restoring element, in particular in the form of an elastic spring, which exerts a restoring force on the valve body, by means of which the valve body is tensioned in the first angular position in the lower stroke end position of the first angular position.

11. The water sports device according to one of claims 3 to 10, wherein
a direction of the stroke axis corresponds to a direction of the axis of rotation.

12. The water sports device according to one of claims 1 to 11, wherein
the mounting is designed such that the valve body, starting from a third angular position, which corresponds neither to the first nor to the second angular position and in which the valve body can adopt a further closed position closing the passage opening, can be brought into a fourth angular position, which corresponds neither to the first nor to the second angular position and in which the valve body can adopt a further open position releasing the passage opening and in which the valve body cannot adopt a closed position, by rotating about the axis of rotation with an actuation angle γ, with 0°<γ<360°, wherein the valve body, starting from the third angular position, can be brought into the fourth angular position by rotating about the axis of rotation with an angle of rotation δₙ=γ+n·360° for every n∈ [symbol] by means of the mounting allowing the continuous rotation.

13. The water sports device according to claim 12, wherein
the mounting is designed such that the valve body, starting from the second angular position, can be brought into the third angular position by rotating about the axis of rotation with an actuation angle θ, with 0°<θ<360°, and α+γ+θ<360° applies, wherein preferably 80°≤α≤100° and/or 80°≤δ≤100° and/or 80°≤θ≤100° applies.

14. The water sports device according to claim 13, wherein
the mounting is designed such that the valve body, starting from the third angular position, can be brought into the first angular position by rotating about the axis of rotation with an actuation angle φ, with 0°<φ<360°, and preferably α+γ+θ+φ=360° applies.

15. The water sports device according to one of claims 1 to 14, wherein
the valve body comprises a closure section adapted to the passage opening, an operating section, via which the valve body can be rotated, and a connecting section arranged therebetween, wherein the mounting engages in particular in the region of the connecting section.

16. The water sports device according to one of claims 1 to 15, wherein
the water sports device is a surf sports device, in particular a wing rig or a kite, and the inflatable structure is preferably an inflatable front tube of the kite or of the wing rig or an inflatable middle tube or transverse tube of the kite or of the wing rig.

17. A valve device for use on a water sports device, in particular a valve device of a water sports device according to one of claims 1 to 16, comprising a valve housing with a passage opening and a valve body for closing the passage opening airtightly, wherein the valve body is movably attached to the valve housing via a mounting,
wherein the valve body is rotatable about an axis of rotation relative to the valve housing via the mounting such that the valve body, starting from a first angular position, in which the valve body can adopt a closed position closing the passage opening, can be brought into a second angular position, in which the valve body can adopt an open position releasing the passage opening and in which the valve body cannot adopt a closed position, by rotating about the axis of rotation with an actuation angle β, with 0°<β≤180°,
and the mounting is designed such that it allows a continuous rotation of the valve body, so that the valve body, starting from the first angular position, can be brought into the second angular position by rotating about the axis of rotation with an angle of rotation αₙ=β+n·360° for every n∈ [symbol] .

18. The valve device according to claim 17, wherein
the valve body comprises a closure section adapted to the passage opening, an operating section, via which the valve body can be rotated, and a connecting section arranged therebetween, wherein the mounting engages in particular in the region of the connecting section.

19. The valve device according to one of claim 17 or 18, wherein
the valve housing has a fastening section which is adapted to a connection adapter which is designed for use with a pump device such that the connection adapter can be brought into interaction with the fastening section by inserting and rotating relative to the valve housing in order to releasably fasten the connection adapter to the valve housing, and the fastened connection adapter can be separated from the fastening section by rotating and extracting from the valve housing in order to release the fastened connection adapter from the valve housing.

20. The valve device according to claim 18 and according to claim 19, wherein
the operating section of the valve body is adapted to an actuating section of the connection adapter such that, by inserting and rotating the connection adapter in order to engage the releasable fastening of the connection adapter to the valve housing, the actuating section rotates the valve body from an angular position, which is not the first angular position, into the first angular position via interaction with the operating section,
and/or the operating section of the valve body is adapted to the actuating section of the connection adapter such that, by rotating the fastened connection adapter in order to release the fastening of the connection adapter to the valve housing, the actuating section rotates the valve body from an angular position, which is not the first angular position, into the first angular position via interaction with the operating section.

21. The valve device according to claim 20, wherein
the valve body is displaceable relative to the valve housing along a stroke axis via the mounting,
a valve stroke in the first angular position is unequal to a valve stroke in the second angular position, wherein the valve stroke describes the possible movement range for stroke movements of the valve body relative to the valve housing along the stroke axis, and
the operating section of the valve body is adapted to the actuating section of the connection adapter such that, by inserting and rotating the connection adapter in order to engage the releasable fastening of the connection adapter to the valve housing, the actuating section displaces the valve body out of a lower stroke end position via interaction with the operating section.

22. A valve system for use on a water sports device, in particular a water sports device according to one of claims 1 to 16, comprising:
23. a connection adapter which can be connected to an outlet of a pump device, and
24. a valve device according to one of claim 20 or 21,
wherein the connection adapter is adapted to the fastening section of the valve housing of the valve device such that the connection adapter can be brought into interaction with the fastening section by inserting and rotating relative to the valve housing in order to releasably fasten the connection adapter to the valve housing, and the fastened connection adapter can be separated from the fastening section by rotating and extracting from the valve housing in order to release the fastened connection adapter from the valve housing,
and the connection adapter has an actuating section which is adapted to the operating section of the valve body of the valve device such that, by inserting and rotating the connection adapter in order to engage the releasable fastening of the connection adapter to the valve housing, the actuating section rotates the valve body from an angular position, which is not the first angular position, into the first angular position via interaction with the operating section,
and/or the operating section of the valve body is adapted to the actuating section of the connection adapter such that, by rotating the fastened connection adapter in order to release the fastening of the connection adapter to the valve housing, the actuating section rotates the valve body from an angular position, which is not the first angular position, into the first angular position via interaction with the operating section.
